(19) United States
(12) Patent Application Publication
(10) Pub. No.: US 2022/0082446 A1
(43) Pub. Date: Mar. 17, 2022

(54) FOOD BARBECUE THERMOMETER

(71) Applicant: Manfeng Chen, Shaoyang (CN)

(72) Inventor: Manfeng Chen, Shaoyang (CN)

(21) Appl. No.: 17/152,807

(22) Filed: Jan. 20, 2021

(30) Foreign Application Priority Data
Sep. 15, 2020 (CN) 202022024439.1

(51) Int. Cl. G01K 1/024; G01K 1/14; G01K 1/08; B67B 7/16; B67B 7/44

(52) U.S. Cl. CPC G01K 1/024; G01K 1/14; G01K 2207/06; B67B 7/16; B67B 7/44; G01K 1/08

(57) ABSTRACT

The invention discloses a food barbecue thermometer, comprising a housing (100), and a PCBA board (4), a waterproof button module (12), an LCD display screen (6), a backlight board and a battery (9) that are provided in the housing (100); the backlight board is arranged on the back of the LCD display screen (6); the housing (100) is rotatably provided with a rotating probe (8) that is electrically controlled to rotate, and is externally connected with a metal wire probe (14). The invention is convenient to carry, has diversified usage scenarios, accurate readings, quick response to read out the measured data, and a buzzer reminder function. In particular, the invention adds a metal wire probe with a long wire to diversify products, which realizes multi-scene use, greatly facilitates the use of family barbecues, and solves the pain points of inconvenient operation.

### BACKGROUND OF THE INVENTION

### 1. Field of the Invention

The invention relates to a thermometer, in particular to a food barbecue thermometer.

### 2. Description of the Related Art

For existing products on the market, the real-time barbecue temperature detection equipment and the oven temperature detection equipment can only be used alone, which is incompatible and the customer experience is inconvenient. Simple food thermometers on the market can only detect with a single needle and can only be used in a single use scenario.

Since the thermometer can only be used to extend the probe into the measured scene, there will be operational problems such as hot for hands and inconvenient readings. If remote temperature detection needs to be realized, it is obviously not enough, so there are big limitations in the use scene.

### SUMMARY OF THE INVENTION

The technical problem to be solved by the invention is to provide a food barbecue thermometer, which modified the waterproof, realized the two-way waterproof of the rotating shaft probe and the 3.5 MM socket probe, added multiple barbecue selection functions on the existing basis, added various types of barbecue temperature fixed-point measurement, added the function of measuring food by a long-distance probe, and solves the deficiencies in the prior art well.

The invention is realized by the following technical solutions: a food barbecue thermometer, comprising a housing, wherein the housing is composed of an upper cover and a bottom cover; the upper cover is installed with a waterproof lens; the housing is provided with a PCBA board, a waterproof button module, an LCD display screen, a backlight board and a battery; the battery is connected to the PCBA board and the LCD display screen; the backlight board is arranged on the back of the LCD display screen;

the housing is rotatably provided with a rotating probe that is electrically controlled to rotate, and is externally connected with a metal wire probe; the metal wire probe is connected to a connecting connector on the PCBA board through a waterproof connector;

one end of the metal wire probe is provided with a flexible connecting wire; one end of the flexible connecting wire is connected to the connecting connector on the PCBA board through the waterproof connector; one end of the rotating probe is rotatably installed on the housing;

the housing is provided with a rotating shaft cover; the rotating shaft cover is rotatably installed on the housing; one end of the rotating probe is fixedly connected with the rotating shaft cover; the middle of the rotating shaft cover is fixedly installed with an electric shaft, and the electric shaft rotates to drive the rotating shaft cover to rotate; the electric shaft is controlled by the waterproof button module through a control module;

the housing is provided with a magnet installation position, and a magnet is installed in the magnet installation position; the housing is further provided with a buzzer, and the buzzer is connected to the PCBA board.

Preferably, the battery is a CR2450 battery; the battery cover is sealed on the outside of the battery; a first waterproof sealing ring is provided on the assembly contact surface of the battery cover and the housing; a second waterproof sealing ring is further provided on the upper and lower sides of the housing and the rotating shaft cover; a third waterproof sealing ring is provided between the upper cover and the bottom cover.

Preferably, the bottom cover is provided with a circular cavity, and the circular cavity is provided with a metal bottle opener.

The advantageous effects of the invention are: through the integration of IC technology, the overall supporting research and development of the product has been improved, a food thermometer that integrates real-time temperature detection and oven temperature detection has been integrated, and IP66 waterproof effect has been achieved, which fills the gap in the market;

the invention can use lengthened wires of different distances to connect, which realizes multi-purpose functions, can quickly test food, and can also be placed in an oven to gradually heat up and track real-time temperature changes; when the temperature reaches the set value, the buzzer sounds to remind, which brings together a one-stop solution for indoor and outdoor multi-purpose use scenarios, so as to achieve dual use of outdoor and indoor ovens;

in particular, the invention adds a metal wire probe with a long wire to diversify products, which realizes multi-scene use, greatly facilitates the use of family barbecues, and solves the pain points of inconvenient operation.

### BRIEF DESCRIPTION OF THE DRAWINGS

In order to explain the embodiments of the invention or the technical solutions in the prior art more clearly, the drawings that need to be used in the description of the embodiments or the prior art will be briefly introduced hereinafter. It is obvious that the drawings in the following description are only some embodiments of the invention; for those of ordinary skill in the art, other drawings can be obtained based on these drawings without creative efforts.

FIG. 1 is a schematic diagram of the front structure of the invention;

FIG. 2 is a perspective view of the invention;

FIG. 3 is a schematic diagram of the internal structure of the invention.

### DETAILED DESCRIPTION OF THE PREFERRED EMBODIMENTS

All the features disclosed in the specification, or all disclosed methods or steps in the process, except for mutually exclusive features and/or steps, can be combined in any manner.

Any feature disclosed in the specification (including any appended claims, abstract and drawings), unless specifically stated, can be replaced by other equivalent or equivalent alternative features. That is, unless otherwise stated, each feature is just one example of a series of equivalent or similar features.

In the description of the invention, it needs to be understood that the orientation or positional relationship indicated by the terms “one end”, “the other end”, “outer”, “upper”, “inner”, “horizontal”, “coaxial”, “center”, “end”, “length”, “outer end”, etc. are based on the orientation or positional relationship shown in the drawings, which are only for the convenience of describing the invention and simplifying the description, rather than indicating or implying that the device or element referred to must have a specific orientation, be constructed and operated in a specific orientation, and therefore cannot be understood as a limitation of the invention.

In addition, in the description of the invention, “plurality” means at least two, such as two, three, etc., unless otherwise specifically defined.

The terms such as “upper”, “above”, “lower”, “below” and the like used in the invention to indicate a relative position in space are used to describe the relationship of one unit or feature relative to another unit or feature as shown in the drawings for the purpose of facilitating explanation. The term of the relative position in space may be intended to include different orientations of the device in use or operation other than those shown in the figures. For example, if the device in the figure is turned over, the unit described as being “lower” or “below” other units or features will be “above” the other units or features. Therefore, the exemplary term “below” can encompass both above and below orientations. A device can be oriented in other ways (rotated by 90 degrees or other orientations), and the space-related descriptors used in this article are explained accordingly.

In the invention, unless otherwise clearly defined and limited, the terms “provided”, “sleeved”, “connected”, “through”, “plug” and other terms should be interpreted broadly; for example, it can be a fixed connection, it can be a detachable connection, or integrated; it can be a mechanical connection or an electrical connection; it can be a direct connection, or an indirectly connection through an intermediate medium, and it can be an internal communication between two elements or the interaction relationship between two elements, unless specifically defined otherwise. For those of ordinary skill in the art, the specific meaning of the above terms in the invention can be understood according to specific circumstances.

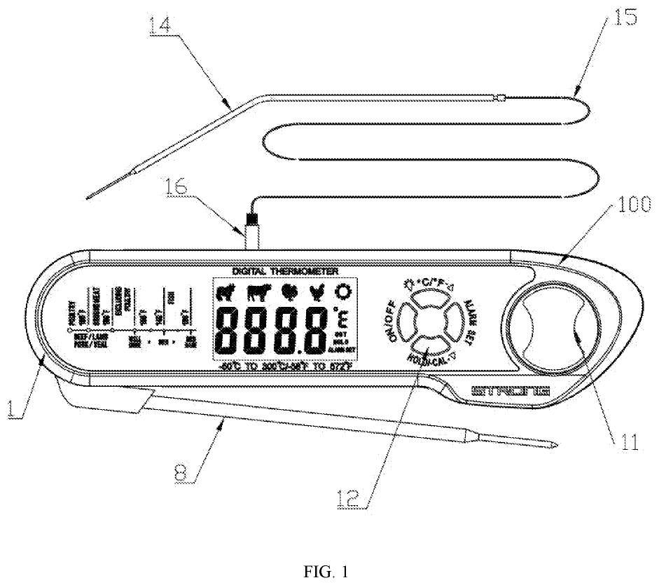

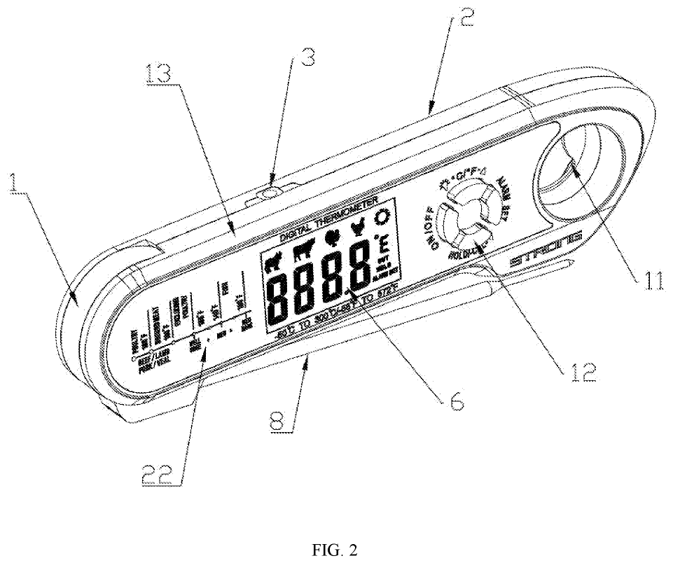

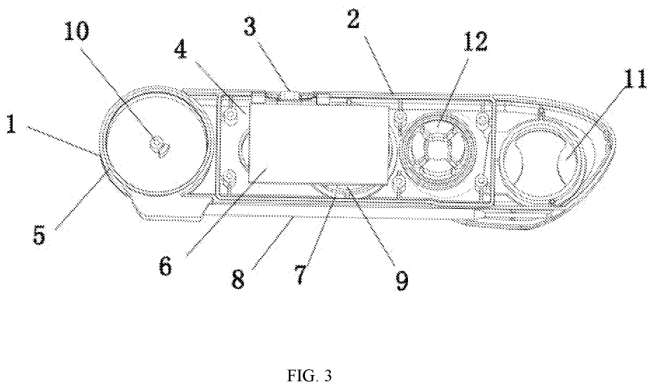

As shown in FIG. 1-3, a food barbecue thermometer of the invention, comprising a housing 100, and a PCBA board 4, a waterproof button module 12, an LCD display screen 6, and a backlight board and a battery 9 that are provided in the housing 100; the battery 9 is connected to the PCBA board 4 and the LCD display screen 6; the backlight board is arranged on the back of the LCD display screen 6; the housing 100 is rotatably provided with a rotating probe 8 that is electrically controlled to rotate, and is externally connected with a metal wire probe 14; the metal wire probe 14 is connected to a connecting connector 3 on the PCBA board 4 through a waterproof connector 16; one end of the rotating probe 8 is rotatably installed on the housing 100.

In the embodiment, the housing 100 is provided with a rotating shaft cover 1; the rotating shaft cover 1 is rotatably installed on the housing 100; one end of the rotating probe 8 is fixedly connected with the rotating shaft cover 1; the middle of the rotating shaft cover is fixedly installed with an electric shaft 10, and the electric shaft 10 rotates to drive the rotating shaft cover to rotate; the electric shaft is controlled by the waterproof button module through a control module. The button control is realized by the electric shaft, and then the rotating shaft cover is automatically rotated, so that the rotating spring needle can be automatically ejected and retracted. The operation is simple, and it can be operated with one key, which is very convenient.

One end of the metal wire probe 14 is provided with a flexible connecting wire 15; one end of the flexible connecting wire 15 is connected to the connecting connector 3 on the PCBA board 4 through the waterproof connector 16. The rotating probe is used for meat, and the metal wire probe is used for grilling.

In the embodiment, the battery 9 is a CR2450 battery; the battery cover 7 is sealed on the outside of the battery 9; a first waterproof sealing ring is provided on the assembly contact surface of the battery cover 7 and the housing 100.

In the embodiment, the housing 100 is composed of an upper cover 13 and a bottom cover 2, which are assembled with each other by screws,; the upper cover 13 is installed with a waterproof lens 22.

The bottom cover 2 is provided with a circular cavity, and the circular cavity is provided with a metal bottle opener 11. By adding the bottle opener, the invention can be used in the field of bottle opening to increase the use function.

A second waterproof sealing ring 5 is further provided on the upper and lower sides of the housing 100 and the rotating shaft cover 1; a third waterproof sealing ring is provided between the upper cover 13 and the bottom cover 2. The waterproof sealing ring is used to increase the waterproof sealing performance after assembly to meet the waterproof grade requirements.

In the embodiment, the housing 100 is provided with a magnet installation position, and a magnet is installed in the magnet installation position; the housing is further provided with a buzzer, and the buzzer is connected to the PCBA board 4. The invention can be attached to some metal parts by magnets, which enables it to be more flexible to use.

For meat mode:

1. turn on the rotating probe and press the “1” key to switch equipment. It takes a long time to turn off this device;

2. press the “2” key to turn on or off the backlight, long press to switch units;

3. press the “4” key to stop displaying the real-time temperature. Long press to calibrate the temperature; please take out a glass of ice water from the refrigerator, insert the probe into the ice water to be in contact with the ice, (make sure the probe to be in contact the ice at ±2° C. when entering the calibration mode), press the “4” key for 5 seconds. The display will quickly show “CAL” on the screen; then the number is displayed;

press the “2” key to increase the number or the “4” key to decrease the number. After waiting for 3 seconds, the screen displays “PASS” and the calibration is complete.

For barbecue mode:

1. press the “1” key to turn on, the shutdown time is long; put away the rotating probe, and insert the metal wire probe into the device; the letter “OUT” will be displayed on the screen;

2. press the “3” key to select the designated meat, the number will flicker. Press the “2” key to increase the number, press the “4” key to decrease the number, and press the “1” key to confirm the set temperature or wait 3 seconds to automatically determine the set temperature;

3. when the set temperature is reached, the alarm will sound an alarm;

4. the device has five food choices by default, such as beef, veal, turkey, chicken; the patterns are set.

The invention is convenient to carry, has diversified usage scenarios, and is suitable for family gathering barbecues, lawn barbecues, field barbecues, baking in ovens, and all-round use. It can be used for both outdoor and indoor ovens, with accurate readings, quick response to read out the measured data, and a buzzer reminder function. When the measured food temperature reaches the temperature we want, a buzzer will sound to remind the user that there are different meat selection functions, and you can freely choose the set temperature according to your own preferences.

The above are only specific embodiments of the invention, but the protection scope of the invention is not limited thereto. Any modifications or replacements without creative efforts shall all be covered by the protection scope of the invention. Therefore, the protection scope of the invention shall be subject to the protection scope defined by the claims.

1. A food barbecue thermometer, comprising a housing (100), wherein the housing (100) is composed of an upper cover (13) and a bottom cover (2); the upper cover (13) is installed with a waterproof lens (22); the housing (100) is provided with a PCBA board (4), a waterproof button module (12), an LCD display screen (6), a backlight board and a battery (9); the battery (9) is connected to the PCBA board (4) and the LCD display screen (6); the backlight board is arranged on the back of the LCD display screen (6);
the housing (100) is rotatably provided with a rotating probe (8) that is electrically controlled to rotate, and is externally connected with a metal wire probe (14); the metal wire probe (14) is connected to a connecting connector (3) on the PCBA board (4) through a waterproof connector (16);
one end of the metal wire probe (14) is provided with a flexible connecting wire (15); one end of the flexible connecting wire (15) is connected to the connecting connector (3) on the PCBA board (4) through the waterproof connector (16); one end of the rotating probe (8) is rotatably installed on the housing (100);
the housing (100) is provided with a rotating shaft cover (1); the rotating shaft cover (1) is rotatably installed on the housing (100); one end of the rotating probe (8) is fixedly connected with the rotating shaft cover (1); the middle of the rotating shaft cover is fixedly installed with an electric shaft (10), and the electric shaft (10) rotates to drive the rotating shaft cover to rotate; the electric shaft is controlled by the waterproof button module through a control module;
the housing (100) is provided with a magnet installation position, and a magnet is installed in the magnet installation position; the housing is further provided with a buzzer, and the buzzer is connected to the PCBA board (4).

2. The food barbecue thermometer according to claim 1, wherein the battery (9) is a CR2450 battery; the battery cover (7) is sealed on the outside of the battery (9); a first waterproof sealing ring is provided on the assembly contact surface of the battery cover (7) and the housing (100); a second waterproof sealing ring (5) is further provided on the upper and lower sides of the housing (100) and the rotating shaft cover (1); a third waterproof sealing ring is provided between the upper cover (13) and the bottom cover (2).

3. The food barbecue thermometer according to claim 1, wherein the bottom cover (2) is provided with a circular cavity, and the circular cavity is provided with a metal bottle opener (11).
